(19) United States
(12) Patent Application Publication
(10) Pub. No.: US 2010/0185302 A1
(43) Pub. Date: Jul. 22, 2010

(54) SYSTEM FOR PROGRAMMING GENERAL USE DEVICES COMMANDED REMOTELY AND METHOD FOR PROGRAMMING GENERAL USE DEVICES COMMANDED REMOTELY

(76) Inventor: Marcos Schwarz, Joinville SC (BR)

Correspondence Address: FAY SHARPE LLP, 1228 Euclid Avenue, 5th Floor, The Halle Building, Cleveland, OH, 44115, US

(21) Appl. No.: 12/691,013

(22) Filed: Jan. 21, 2010

(30) Foreign Application Priority Data
Jan. 22, 2009 (BR) PI0900528-5

(51) Int. Cl. G05B 11/01

(52) U.S. Cl. 700/11

(57) ABSTRACT

The present invention refers to a system for programming general use devices commanded remotely, said system being able to store one or more function codes sent by any master device, and execute, in sequence, the function corresponding to the function code stored.

Said system comprises at least a command device (3), at least a sensor element (2) and a remote control device (5), the sensor element (2) being electrically associated to the command device (3), the command device (3) being able to process a control signal (4) sent by the remote control device (5) by way of the sensor element (2), the command device (3) being able to store a first function code (100) sent by the remote control device (5) in a programming time (tₚ) less than a cut time (t₁) and able to store a second function code (200) sent by the remote control device (5) after an off-on cycle of the command device (3) in a programming time (tₚ) less than a cut time (t₁).

### CROSS-REFERENCE TO RELATED APPLICATION

This application claims priority of Brazilian patent case No. PI0900528-5 filed on Jan. 22, 2009, the disclosure thereof being hereby incorporated by reference.

### FIELD

The present invention refers to a system for programming general use devices commanded remotely, said system being able to store one or more function codes sent by a remote control device and execute, in sequence, the function corresponding to the function code stored.

The present invention also refers to a method for programming general use devices commanded remotely.

### BACKGROUND

Systems containing devices commanded remotely are generally widespread and used in electrical home appliances or business equipment, such as: air-conditioning units, sound systems, televisions, image projectors, among others.

These usually are provided with infra-red signal receptors or radio signals installed in the elements or equipment, commanded remotely.

Remotely controlled equipments are usually named servo, and are controlled by a device referred to as master device.

Normally, receiver or servo equipments, as well as master devices, have a communication system based on a dedicated protocol and specific commands. This being a dedicated solution, but with the drawback of a restricted arrangement which does not allow possible changes in accordance with the user's interest.

Other types of equipment controlled remotely are also used in the state of the art based on an arrangement in which a servo device at a certain moment assumes the function of master.

This arrangement allows the simulation of the behavior of the master devices in a similar manner to the original master. This structure is also used in some network topologies specially developed with this feature.

A major limitation of the solutions available today on the market refers to the use of a known master element for each servo device used.

Based on the above, the present invention offers a system for programming general use devices commanded remotely, such as electrical home appliances, or industrial instruments, capable of processing signals originating from various types of master devices, based on the programming now proposed.

Said programming enables one or more servo devices to obey/respond a new master device by means of the present programming system.

### OBJECTIVES OF THE INVENTION

A first objective of the present invention is to propose a system for programming general use devices commanded remotely, said system being able to store one or more function codes sent by any master device, and execute, in sequence, the function corresponding to the function code stored.

A second objective of the present invention is to propose a method for programming general use devices commanded remotely, capable of allowing the programming of one or more function commands for a command device.

### BRIEF DESCRIPTION OF THE INVENTION

A means of achieving the objectives of the present invention is by providing a system for programming general use devices commanded remotely comprising at least a command device, at least a sensor element and a remote control device, the sensor element being electrically associated to the command device, the command device being able to process a control signal sent by the remote control device by way of the sensor element, the command device being able to store a first function code sent by the remote control device in a programming time less than a cut time and able to store a second function code sent by the remote control device after an off/on cycle of the command device in a programming time less than a cut time.

A second means of achieving the objectives of the present invention is by providing a method for programming general use devices commanded remotely, comprising at least a command device, at least a sensor element and a remote control device, the command device being electrically associated to the sensor element, comprising the following steps:

provide electric power to the command device;

provide a control signal to the command device emitted by the remote control device;

memorize a first function code in the command device if the emission of the control signal is interrupted in a programming time less than the cut time;

turn off the electric power of the command device for a period of time greater than a minimum time and less than a maximum time;

provide electric power to the command device; and

memorize a second function code in the command device if the emission of the control signal is interrupted in a programming time less than the cut time.

### BRIEF DESCRIPTION OF THE DRAWINGS

The present invention will now be described in greater detail, with reference to the appended drawings, wherein:

FIG. 1-represents a schematic view of the system for programming devices, the object of the present invention;

FIG. 2-represents a first flowchart of the programming steps of the command device, for a first function code, in accordance with the teachings of the present invention; and

FIG. 3-represents a second flowchart of the programming steps of the command device, for a second function code, object of the present invention.

### DETAILED DESCRIPTION

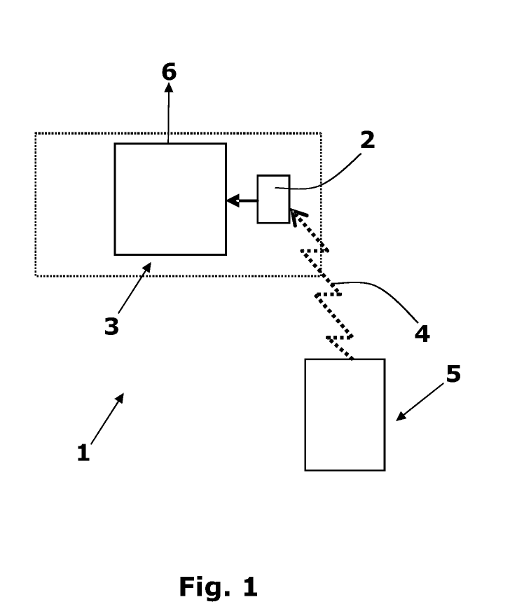

FIG. 1 illustrates a schematic view of the system for programming general use devices commanded remotely, in accordance with the teachings of the present invention.

As mentioned previously, state of the art solutions usually employ servo devices that only respond to a specific master device.

In the present invention, the user has the possibility of programming a servo command device based on any master device, it being possible, in sequence, to execute the function programmed when driving the respective master.

The system for programming general use devices commanded remotely 1, the object of the present invention, comprises at least a command device 3, at least a sensor element 2 and a remote control device 5. FIG. 1 shows the general structure of the system now proposed.

Said command device 3 is responsible for executing a series of functions 6, such as: turning on an electrical home appliance, switching off a light, and adjusting television set operation parameters, among others.

FIG. 1 also illustrates that the sensor element 2 is electrically associated to the command device 3.

Therefore, the command device 3 is capable of processing a control signal 4 sent by the remote control device 5 by way of the sensor element 2.

Preferably, said communication can be normally established by way of infra-red signal, or by radio signals. In any case, other wireless communication means can be used in order to carry out the present invention.

The sensor element 2 is normally a semi-conductor device of the photo-transistor or photodiode kind. In any case, other devices can be used, such as a variable resistor with a visible light (L-DR).

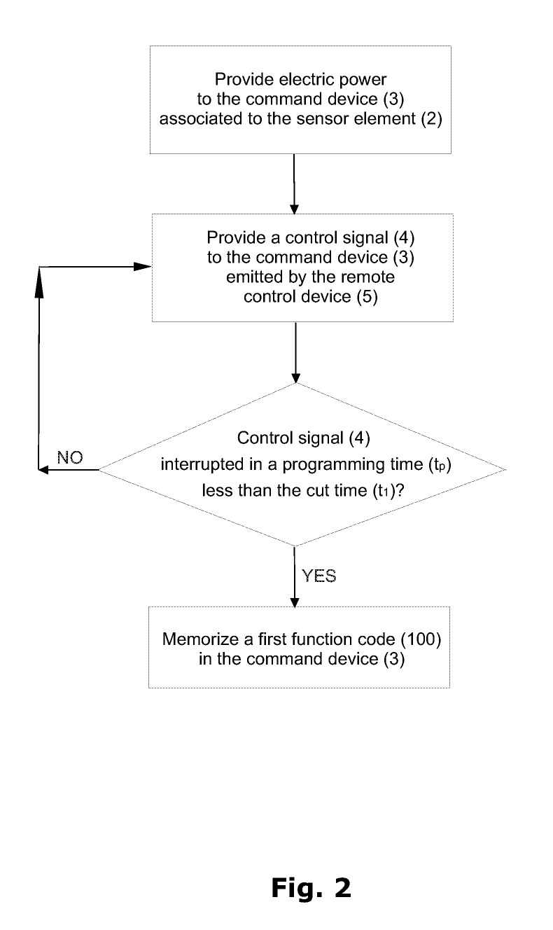

According to the teachings of the present invention, and as shown in FIG. 2, the command device 3 is capable of storing a first function code 100 sent by the remote control device 5, provided that said emission occurs in a programming time tₚ less than a cut time t₁.

After storing said first function code 100, the command device 3 is capable of executing a function 6, sent afterwards by the remote control device 5, corresponding to the first function code 100 previously stored.

If the user wishes to use any other remote control device 5, which corresponds herein to the master element in the communication, it is possible to store another function code, such as the object of the invention now claimed.

Accordingly, the present system for programming general use devices commanded remotely 1 is capable of storing a second function code 200, also sent by the remote control device 5, after an off/on cycle of the command device 3 in a programming time tₚ less than a cut time t₁.

It is important to highlight that the off/on cycle of the command device 3 comprises a period of time greater than a minimum time t₂ and less than a maximum time t₃. For said off/on cycle, said period is necessary for suitable cancellation of the first function code 100 previously stored in the command device 3.

A preferred embodiment for the present system provides the user with the possibility of adjusting the minimum t₂ and maximum t₃ programming times.

As already mentioned, the command device 3, in accordance with the teachings of the present invention, is able to recognize in sequence the first function code 100 sent by the remote control device 5 in a command time t_{c} subsequent to the programming time tₚ.

Analogously, the command device 3 is able to recognize the second function code 200 sent by the remote control device 5 in a command time t_{c} subsequent to the programming time tₚ, when it is stored in the internal memory of the command device 3.

Said internal memory may comprise a semi-conductor or magnetic element.

Once again, it is important to emphasize that the storage of the first 100 and second 200 function codes is provided, preferably, by means of an infra-red control signal sent by the remote control device 5.

The remote control device 5, pursuant to the present invention, is a universal remote control.

Additionally, the object of the invention now proposed provides a method for programming general use devices commanded remotely, comprising:

at least a command device 3;

at least a sensor element 2; and

a remote control device 5.

The command device 3 is electrically associated to the sensor element 2, said method having the following steps:

provide electric power to the command device 3;

provide a control signal 4 for the command device 3 emitted by the remote control device 5;

memorize the first function code 100 in the command device 3 if the emission of the control signal 4 is interrupted in a programming time tₚ less than the cut time

turn off the electric power of the command device 3 for a period of time greater than a minimum time t₂ and less than a maximum time t₃;

provide electric power to the command device 3;

memorize a second function code 200 in the command device 3 if the emission of the control signal 4 is interrupted in a programming time tₚ less than the cut time t₁.

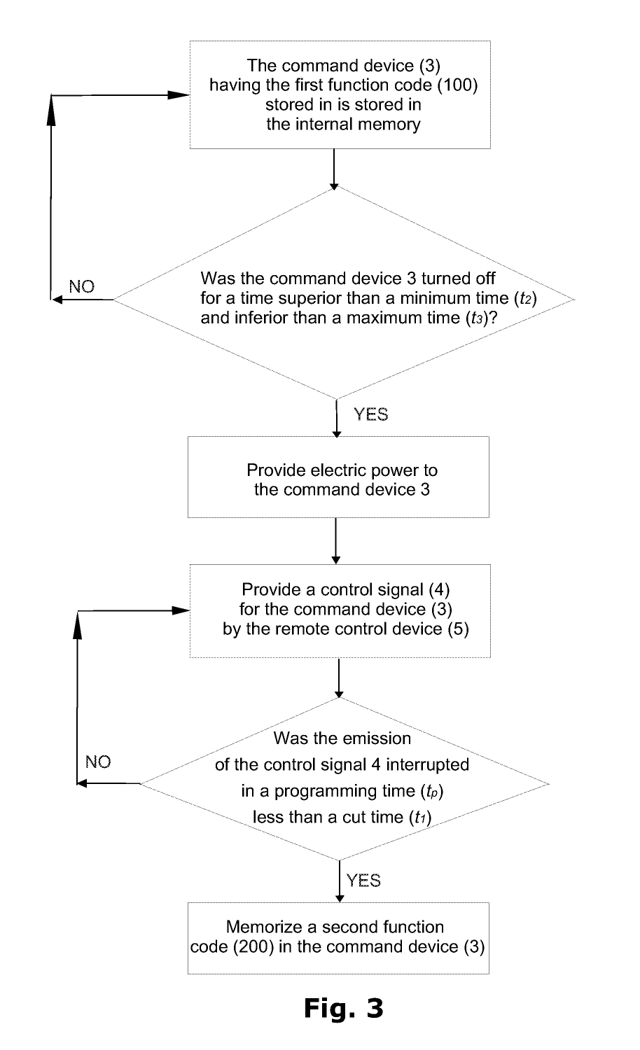

FIGS. 2 and 3 illustrate, by means of a flowchart, the phases involved in the programming process of the first 100 and second 200 function codes respectively.

Based on the above, it can be noted that the present invention offers a simple and efficient system and method for programming general use devices compared to prior arts, providing the end use of the system utilize various kinds of master devices, such as differentiated remote controls, in order to control the command device 3.

Having described examples of preferred embodiments, it must be understood that the scope of the present invention encompasses other possible variations, and is only limited by the content of the claims appended hereto, potential equivalents being included therein.

1. System for programming general use devices commanded remotely (1), comprising:
at least a command device (3);
at least a sensor element (2); and
a remote control device (5),
the sensor element (2) being electrically associated to the command device (3), the command device (3) being able to process a control signal (4) sent by the remote control device (5) by way of the sensor element (2), the system for programming general use devices commanded remotely (1), wherein the command device (3) is able to store a first function code (100) sent by the remote control device (5) in a programming time (tₚ) less than a cut time (t₁) and able to store a second function code (200) sent by the remote control device (5) after an off/on cycle of the command device (3) in a programming time (tₚ) less than a cut time (t₁).

2. System for programming general use devices commanded remotely (1), according to claim 1, wherein the off/on cycle of the command device (3) comprises a period of time greater than a minimum time (t₂) and less than a maximum time (t₃).

3. System for programming general use devices commanded remotely (1), according to claim 1, wherein the command device (3) is able to recognize the first function code (100) sent by the remote control device (5) in a command time (t_{c}) subsequent to the programming time (tₚ).

4. System for programming general use devices commanded remotely (1), according to claim 1, wherein the command device (3) is able to recognize the second function code (200) sent by the remote control device (5) in a command time (t_{c}) subsequent to the programming time (tₚ).

5. System for programming general use devices commanded remotely (1), according to claim 1, wherein the storage of the first and second function codes (100,200) is provided by an infra-red control signal sent by the remote control device (5).

6. System for programming general use devices commanded remotely (1), according to claim 1, wherein the remote control device (5) is a universal remote control.

7. System for programming general use devices commanded remotely (1), according to claim 1, wherein the sensor element (2) is a photodiode or a phototransistor.

8. Method for programming general use devices commanded remotely, comprising:
at least a command device (3);
at least a sensor element (2); and
a remote control device (5),
the command device (3) being electrically associated to the sensor element (2), the method for programming general use devices being characterized by comprising the following steps:
provide electric power to the command device (3);
provide a control signal (4) to the command device (3) emitted by the remote control device (5);
memorize a first function code (100) in the command device (3) if the emission of the control signal (4) is interrupted in a programming time (tₚ) less than the cut time (t₁),
turn off the electric power of the command device (3) for a period of time greater than a minimum time (t₂) and less than a maximum time (t₃);
provide electric power to the command device (3);
memorize a second function code (200) in the command device (3) if the emission of the control signal (4) is interrupted in a programming time (tₚ) less than the cut time (t₁).

9. Method for programming general use devices commanded remotely, according to claim 8, wherein the sensor element (2) is operated by an infra-red signal or a visible light.

10. Method for programming general use devices commanded remotely, according to claim 8, wherein the remote control device (5) is a universal remote control.
